(19) United States
(12) Patent Application Publication
(10) Pub. No.: US 2024/0355326 A1
(43) Pub. Date: Oct. 24, 2024

(54) SPEECH INPUT SUPPORT DEVICE AND STORAGE MEDIUM

(71) Applicant: KABUSHIKI KAISHA TOSHIBA, Tokyo (JP)

(72) Inventors: Kenji IWATA, Machida Tokyo (JP); Nayuko WATANABE, Kawasaki Kanagawa (JP)

(73) Assignee: KABUSHIKI KAISHA TOSHIBA, Tokyo (JP)

(21) Appl. No.: 18/441,384

(22) Filed: Feb. 14, 2024

(30) Foreign Application Priority Data
Apr. 19, 2023 (JP) 2023-068567

(51) Int. Cl. G10L 15/22; G10L 25/51

(52) U.S. Cl. CPC G10L 15/22; G10L 25/51

(57) ABSTRACT

According to one embodiment, a speech input support device includes a recording unit and a processor. The recording unit records speech of a user using a speech input device. The processor includes hardware. The processor recognizes the recorded speech separately from speech recognition for input of a first recording content by the speech input device. The processor generates a second recording content based on a result of the separately recognized speech and a next operation for the user for the input using the speech input device. The processor compares the first recording content with the second recording content.

### CROSS-REFERENCE TO RELATED APPLICATION

This application is based upon and claims the benefit of priority from prior Japanese Patent Application No. 2023-068567, filed Apr. 19, 2023, the entire contents of which are incorporated herein by reference.

### FIELD

Embodiments described herein relate generally to a speech input support device and a storage medium BACKGROUND

In a variety of business operations such as service, manufacturing, and maintenance and inspection, speech input is often useful from the viewpoint of improving the efficiency of recording operations. Speech input devices for use in speech input in these business operations recognize speech input from an operator to respective items in entry fields represented in the form of a table in a ledger, for example, and record the speech-recognized contents in their corresponding items.

In recent years, a framework for further improving the accuracy of speech recognition has been required. At the maintenance and inspection site in particular, there is a possibility that a speech input device cannot be connected to the network. In this case, the speech recognition is performed on a terminal with limited specifications that can be brought to the maintenance and inspection site. It is desirable to improve the accuracy of speech recognition even in such a terminal with limited specifications.

As a method for improving the accuracy of speech recognition, speech input is recognized by a speech recognition engine other than a speech recognition engine for speech input, and a result of the recognition obtained from the speech recognition engine for speech input is compared with a result of the recognition obtained from the other speech recognition engine.

It is here important to determine which item corresponds to a speech input to each item in the entry field. On the other hand, the input speech does not necessarily include information indicating the item. If the input speech does not include the information, it is difficult to properly compare a result of recognition obtained from a speech recognition engine for speech input with a result of recognition obtained from another speech recognition engine. It is more difficult to compare them properly in terminals with limited specifications in particular.

### BRIEF DESCRIPTION OF THE DRAWINGS

FIG. 1 is a block diagram showing a configuration of a speech input device according to an embodiment.

FIG. 2 is a diagram showing an example of a hardware configuration of the speech input device according to the embodiment.

FIG. 3 is a flowchart showing an operation of a speech input processing unit of the speech input device according to the embodiment.

FIG. 4 is a flowchart showing an operation of a recording content comparison unit of the speech input device according to the embodiment.

FIG. 5 is a diagram showing input to items by speech using the speech input device according to the embodiment.

FIG. 6 is a diagram showing an example of a screen of results of comparison between a first recording content and a second recording content.

### DETAILED DESCRIPTION

In general, according to one embodiment, a speech input support device includes a recording unit and a processor. The recording unit records speech of a user using a speech input device. The processor includes hardware. The processor recognizes the recorded speech separately from speech recognition for input of a first recording content by the speech input device. The processor generates a second recording content based on a result of the separately recognized speech and a next operation for the user for the input using the speech input device. The processor compares the first recording content with the second recording content.

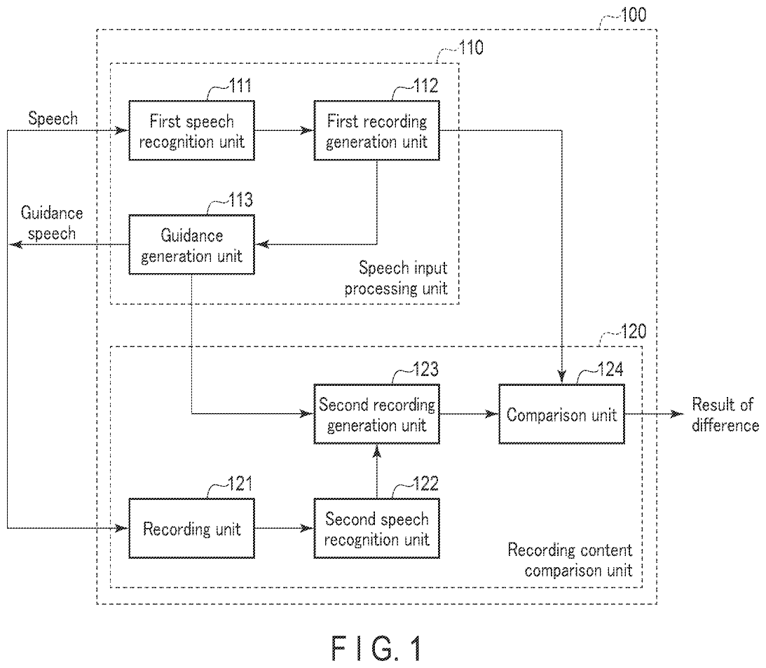

An embodiment will be described below. FIG. 1 is a block diagram showing a speech input device 100 according to the embodiment. The speech input device 100 is a computer mainly including a speech input processing unit 110 and a recording content comparison unit 120 as a speech input support device. The speech input device 100 may be a variety of computers such as a personal computer, a smartphone and a tablet. The recording content comparison unit 120 may be provided separately from the speech input device 100.

The speech input processing unit 110 recognizes speech input from a user to generate a first recording content while performing an operation of guiding speech input to the user. The recording content comparison part 120 recognizes the speech input from the user separately from the speech input processing unit 110 to generate a second recording content. Then, the recording content comparison unit 120 presents a difference between the first and second recording contents to the user.

The speech input processing unit 110 includes a first speech recognition unit 111, a first recording generation unit 112 and a guidance generation unit 113.

The first speech recognition unit 111 recognizes the speech of a user and outputs a result of the speech recognition to the first recording generation unit 112. The first speech recognition unit 111 includes a speech recognition engine, which may include a plurality of speech recognition engines corresponding to uses. For example, if the use of speech input is to input numerical values to a ledger or the like, the speech recognition engine includes a speech recognition engine corresponding to grammar recognition in which only the numerical value candidates are described in the grammar. If the use of speech input is to record comments such as noticing during operation, the speech recognition engine includes a speech recognition engine corresponding to large-vocabulary speech recognition capable of recognizing free text. If it is necessary to recognize a speech command of operating the speech input device 100, such as “undo,”, the speech recognition engine includes a speech recognition engine utilizing a voice trigger which recognizes a specific speech keyword only. These speech recognition engines may always be running simultaneously. In this case, each of the speech recognition engines outputs a recognition result with a confidence level, and the first speech recognition unit 111 may employ a recognition result with the highest confidence level. Alternatively, the first speech recognition unit 111 may preferentially employ the first determined recognition result from the speech recognition engines. In the embodiment, the speech input device 100 guides speech input. That is, in the speech input device 100, the type of recording contents to be entered each time is often determined. If it is determined whether the type of recording contents to be entered next is a numerical value, a comment or a speech command, the first speech recognition unit 111 may select a suitable speech recognition engine.

The first recording generation unit 112 generates recording contents based on the speech recognition result input from the first speech recognition unit 111. The first record generation unit 112 generates recording contents corresponding to a next operation for a user held in the guidance generation unit 113. For example, if the next operation is to guide input to data items in the form of a table in a ledger or the like, the first recording generation unit 112 generates recording contents in which the data item and the speech recognition result are caused to correspond to each other. If there are a plurality of items, the recording contents are updated each time speech is input. In addition, if the first recording generation unit 112 is supplied from the first speech recognition unit 111 with a result of recognition of speech unsuitable for a next operation, it rejects the result of recognition. For example, if the first recording generation unit 112 is supplied with an unexpected recognition result such as an alphabetical character when a next operation is to guide numerical values to be entered, it rejects the recognition result. In this case, the first recording generation unit 112 may request the guidance generation unit 113 to guide numerical values to be entered next. On the other hand, if the first recording generation unit 112 is supplied from the first speech recognition unit 111 with a result of recognition of speech suitable for a next operation, it accepts the result of recognition. In either case where the first recording generation unit 112 rejects or accepts the recognition result, the first recording generation unit 112 supplies the guidance generation unit 113 with information as to whether it has accepted the current recording contents and the present speech recognition result. When all speeches are completely input, the first recording generation unit 112 supplies the comparison unit 124 with the finally reflected recording content as a first recording content.

The guidance generation unit 113 determines the next operation based on information as to whether the recording contents generated by the first recording generation unit 112 and the present speech recognition result have been accepted, generates a guidance speech corresponding to the operation, and presents it to the user. The guidance generation unit 113 holds information for generating the guidance speech. This information includes, for example, information on the order of respective operations, information on the type of speech to be input for each of the operations, and information on guidance wording for generating the actual guidance speech corresponding to each of the operations. The guidance generation unit 113 can determine the next guidance speech based on information as to whether the recording contents received from the first recording generation unit 112 and the present speech recognition result have been accepted. Existing speech synthesis technology may be utilized to generate the guidance speech. Note that the guidance generation unit 113 may display guidance to the user in place of or in addition to the guidance speech as the next operation.

The recording content comparison unit 120 includes a recording unit 121, a second speech recognition unit 122, a second recording generation unit 123 and a comparison unit 124.

The recording unit 121 collectively records user's speech and guidance speech and stores them as a single speech file. Then, the recording unit 121 inputs the speech file to the second speech recognition unit 122 as necessary.

The second speech recognition unit 122 recognizes speech for the speech file received from the recording unit 121 and outputs a result of the speech recognition to the second recording generation unit 123. Like the first speech recognition unit 111, the second speech recognition unit 122 may include a plurality of speech recognition engines corresponding to uses. The speech recognition engine used in the second speech recognition unit 122 may be the same as the speech recognition engine used in the first speech recognition unit 111, but they are preferably different from each other. For example, the speech recognition engine used in the first speech recognition unit 111 can be an engine that saves memory but has a moderate recognition accuracy because it preferably operates at a high speed even in a place where it cannot be connected to a network. On the other hand, the speech recognition engine used in the second speech recognition unit 122 is an engine that can be used in a place where it can be connected to a network, and can be, for example, a cloud-based high-accuracy engine.

The second recording generation unit 123 generates a second recording content based on a result of the speech recognition input from the second speech recognition unit 122. Like the first recording generation unit 112, the second recording generation unit 123 generates recording contents corresponding to the next operation for user held by the guidance generation unit 113. The operation of the second recording generation unit 123 will be described in detail later. The second recording generation unit 123 supplies the second recording content to the comparison unit 124.

The comparison unit 124 compares the first recording content input from the first recording generation unit 112 with the second recording content input from the second recording generation section 123, and presents a result of the comparison to the user. The method of presenting the result to the user may, for example, be performed by emphasizing the difference between two recording contents while simultaneously presenting them to the user or may be performed by simultaneously presenting two recording contents only with a difference while presenting only one of the recording contents with no difference.

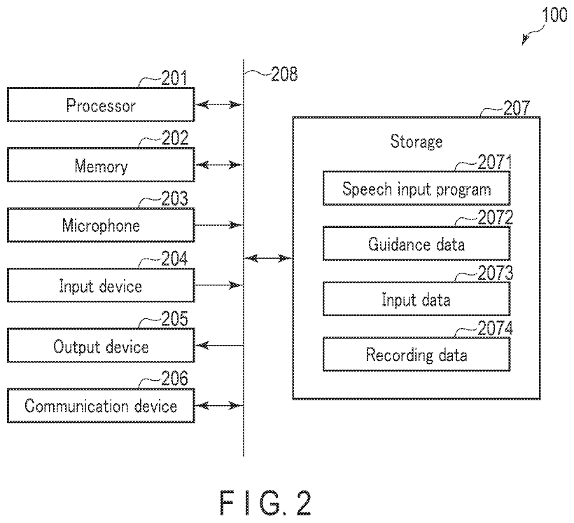

Next is a description of an example of hardware configuration of the speech input device. FIG. 2 is a diagram showing an example of the hardware configuration of the speech input device 100. The speech input device 100 is a computer and includes, as hardware, a processor 201, a memory 202, a microphone 203, an input device 204, an output device 205, a communication device 206, a storage 207 and the like. The processor 201, memory 202, microphone 203, input device 204, output device 205, communication device 206 and storage 207 are connected to a bus 208. FIG. 2 shows the hardware configuration of the speech input device 100, but as described above, the recording content comparison unit 120 may be provided separately from the speech input device 100 and in this case the recording content comparison unit 120 may have the same configuration as that in FIG. 2. If, however, the recording content comparison unit 120 is provided separately from the speech input device 100, it need not include a microphone 203 or the like related to the input of speech.

The processor 201 controls the overall operation of the speech input device 100. The processor 201 may operate as a speech input processing unit 110 and a recording content comparison unit 120 by executing a speech input program 2071 stored in the storage 207, for example. The processor 201 is, for example, a CPU. The processor 201 may be an MPU, a GPU, an ASIC, an FPGA, etc. The processor 201 may be a single CPU or a plurality of CPUs. As described above, the speech recognition engine used in the second speech recognition unit 122 may be a cloud-based engine. In this case, it goes without saying that the processor serving as the second speech recognition unit 122 may be provided separately from the speech input device 100.

The memory 202 includes a ROM and a RAM. The ROM is a nonvolatile memory. The ROM stores a start program and the like of the speech input device 100. The RAM is a volatile memory. The RAM is used as a working memory for processing in the processor 201, for example.

The microphone 203 converts the speech input from a user into an electrical signal. The signal of the sound obtained via the microphone 203 is stored in the RAM, for example. Then, the processor 201 recognizes the speech.

The input device 204 is an input device such as a touch panel, a keyboard and a mouse. When the input device 204 is operated, a signal corresponding to the operation contents is input to the processor 201 via the bus 208. The processor 201 performs various processes in response to the signal.

The output device 205 is an output device to output various types of information. The output device 205 may include a display device such as a liquid crystal display and an organic EL display to display an entry screen for a ledger or the like. The output device 205 may also include a speaker to output guidance speech. The output device 205 need not necessarily be provided in the speech input device 100, but may be an external output device capable of communicating with the speech input device 100.

The communication device 206 is a communication device for the speech input device 100 to communicate with an external device. The communication device 206 may be a communication device for wired communications or a communication device for wireless communications.

The storage 207 is, for example, a hard disk drive or a solid-state drive. The storage 207 stores a variety of programs to be executed by the processor 201, such as a speech input program 2071. The speech input program 2071 includes a program for causing the processor 201 to execute various processes for speech input. The processes for speech input include a process of outputting various types of guidance speech in accordance with guidance data 2072, a process of recognizing a speech input from a user using a speech recognition engine for speech input, and a process of recording the recognized contents. The speech input program 2071 also includes a speech input support program for causing the processor 201 to execute various processes for supporting the input of user's speech. Various processes for speech input support include a process of recording a speech input from a user and the like, a process of recognizing the recorded speech using a speech recognition engine other than the speech recognition engine for inputting the recorded speech, a process of associating the recognized content with the next operation in accordance with the guidance data 2072, and a process of comparing the content recognized by the speech recognition engine for speech input with the content recognized by the speech recognition engine other than the speech recognition engine for speech input.

The storage 207 may also store the guidance data 2072, input data 2073 and recording data 2074.

The guidance data 2072 is data for generating guidance speech, and includes, for example, data of the order of respective operations, data of the type of speech to be input in each of the operations, and data of the wording of guidance for generating the actual guidance speech corresponding to each of the operations.

The input data 2073 includes the first and second recording contents. That is, the input data 2073 includes data of the first recording content obtained as a result of recognizing the speech input by a user using the speech recognition engine as the first speech recognition unit 111 and data of the second recording content obtained as a result of recognizing the speech input by a user and the guidance speech using the speech recognition engine as the second speech recognition unit 122. As described above, data of the next operation is associated with the data of the first recording content and the data of the second recording content.

The recording data 2074 is recording data of the speech input by the user and the guidance speech.

The bus 208 is a data transfer path for data exchange between the processor 201, memory 202, microphone 203, input device 204, output device 205, communication device 206 and storage 207.

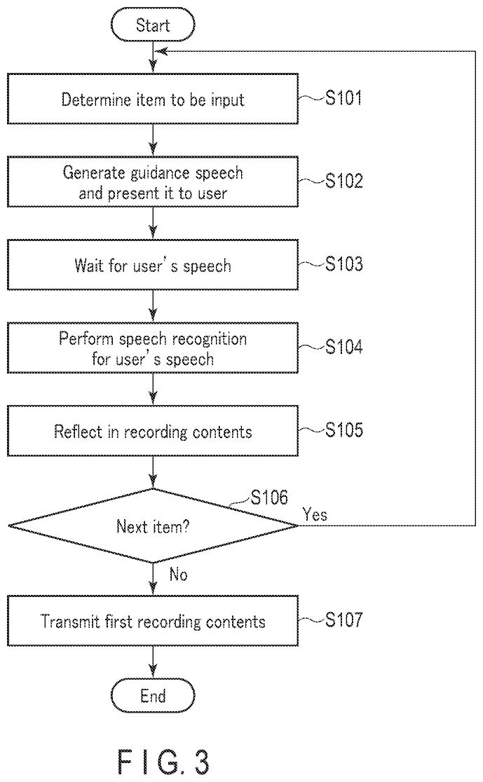

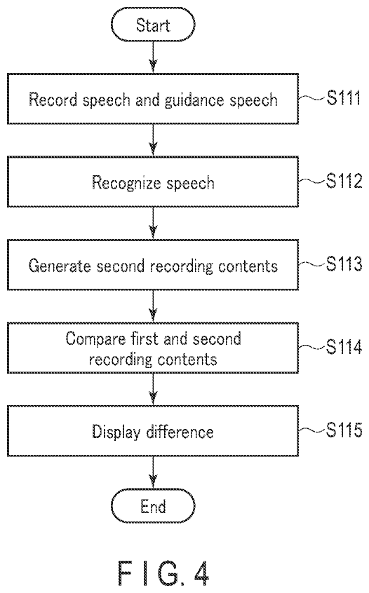

Next is a description of the operation of the speech input device 100. FIGS. 3 and 4 are flowcharts showing the operation of the speech input device 100. FIG. 3 is a flowchart showing the operation as that of the speech input processing unit 110. FIG. 4 is a flowchart showing the operation as that of the recording content comparison unit 120. The processes shown in FIGS. 3 and 4 are started when the speech input program 2071 is started. Below is a description of an example in which data is entered in data items represented in the form of a table of a ledger or the like by speech input by the speech input device 100.

First, the operation of the speech input processing unit 110 will be described with reference to FIG. 3. In step S101, the speech input processing unit 110 causes the guidance generation unit 113 to determine an item to be entered by a user next. The order of items to be entered by the user is held, for example, as guidance data 2072 of the storage 207. For example, the guidance generation unit 113 selects the items recorded as the guidance data 2072 in order from the top to determine an item to be entered by the user next.

In step S102, the speech input processing unit 110 causes the guidance generation unit 113 to generate a guidance speech corresponding to an item to be entered by the user and present the guidance speech to the user through a speaker, for example.

In step S103, the speech input processing unit 110 waits for a user's speech. When the user's speech is recorded in the first speech recognition unit 111, the process proceeds to step S104.

In step S104, the speech input processing unit 110 causes the first speech recognition unit 111 to perform speech recognition for the user's speech.

In step S105, the speech input processing unit 110 causes the first recording generation unit 112 to record a recognition result, which is obtained from the first speech recognition unit 111, in, for example, the storage 207 as a recording content. If the recognition result is inappropriate for the current item, it can be rejected. If the recognition result is a speech command to the speech input device 100, a process may be performed in response to the speech command.

In step S106, the speech input processing unit 110 determines whether there is an item to be entered next, based on the order of items to be entered by the user. If the speech input processing unit 110 determines in step S106 that there is an item to be entered next, the process returns to step S101. In this case, the same process is performed for the next item. If the speech input processing unit 110 determines in step S106 that there is no item to be entered next, i.e., that input to all items has been completed, the process proceeds to step S107.

In step S107, the speech input processing unit 110 transmits a series of recording contents recorded in the first recording generation unit 112 to the comparison unit 124 as a first recording content. After that, the process of FIG. 3 ends.

The operation of the recording content comparison unit 120 will be described below with reference to FIG. 4. Note that it is assumed in the example described below that the input to items is completed and then the second recording content is generated using a series of user's speeches and guidance speeches until then.

In step S111, the recording content comparison unit 120 causes the recording unit 121 to record user's speech and guidance speech. The process of step S111 is performed in parallel with the process of FIG. 3. On the other hand, the processes of step S112 and its subsequent steps need not be performed in parallel with the process of FIG. 3, but may be performed after the entry of the items is completed.

In step S112, the recording content comparison unit 120 causes the second speech recognition unit 122 to recognize the speech recorded by the recording unit 121.

In step S113, the recording content comparison unit 120 causes the second recording generation unit 123 to generate a second recording content. Then, the second recording generation unit 123 generates the second recording content by associating item information with a recognition result in the second speech recognition unit 122 based on guidance data held in the storage 207, for example, and transmits the generated second recording content to the comparison unit 124.

In step S114, the recording content comparison unit 120 causes the comparison unit 124 to compare the first and second recording contents. The comparison is performed, for example, by calculating a difference in character string between the recognition results.

In step S115, the recording content comparison unit 120 causes a display device of the output device 205, for example to display to the user a difference in comparison result between the first and second recording contents, which is obtained from the comparison unit 124. After that, the process of FIG. 4 ends. Note that the display may be performed on a display device of a terminal other than the speech input device 100.

Here is a further description of a method of associating the speech recognition results in step S113 with the items. As described above, the guidance data 2072 stored in the storage 207, for example includes information on the order of items to be entered. If, therefore, a guidance speech and a user's speech are recorded as they are while maintaining the order of the speeches, the speech recognition result of the user's speech can be associated with the items in the entering order or in the entering time order. However, the user's speech may include speeches that have been rejected at the time of recording, speeches made by the user when the speech input device 100 is not waiting for the user's speech during the output of guidance speech, and the like. In this case, a simple method results in misalignment between the speech recognition results and items.

It is therefore desirable to utilize the recognition results of the guidance speech. The guidance speech includes wording representing an item, such as an item name, in order to prompt a user to enter the item. Therefore, the second recording generation unit 123 grasps which item is one to be entered from the recognition results of the guidance speech, and associates the recognition results of the user's speech with the item. Accordingly, they can appropriately be associated with each other.

On the other hand, in order to achieve the above process, the user's speech and the guidance speech need to be correctly identified. A method of performing the identification may include a method of recording a user's speech and a guidance speech separately, a method of applying a speaker identification technique to the speeches recorded collectively, and the like. In the speaker identification technique, the quality of the guidance speech is known in advance, and the speech has only to be identified from other speeches. In the speaker identification technique, therefore, high accuracy of identification is expected. The identification performing method includes another method of detecting part that appears to be a guidance speech from the speech recognition results and separating the detected part based on the detected part. Since the wording of the guidance speech is predetermined, this method is considered to be effective as long as the user does not speech the same wording as the guidance speech.

The foregoing descriptions are made on the premise that the accuracy of the speech recognition results obtained from the second speech recognition unit 122 is high. In practice, speech recognition errors tend to occur because there are a lot of technical terms for item names and the like. In the recognition of the technical terms, it is effective to register the technical terms in the dictionary of the speech recognition engine of the second speech recognition unit 122 in advance. In addition, as a result of matching the wording of the guidance with the speech recognition results at the phoneme level, if an error is equal to or less than a certain level, the speech recognition results represent the guidance speech. This method is also effective in the user's speech. If, for example, the speech input device 100 is waiting only numerical values and the recognition results of the second speech recognition unit 122 are not numerical values, they may be converted to the nearest numerical values among the results of matching at the phoneme level. It is thus expected that the second recording content will become more accurate.

In addition, as described above, there may be a case where the user's speech includes not only a value but also a speech command such as “undo.” By taking the case into consideration, the recognition results and items need to be associated with each other. If the speech command “undo” exists in the speech recognition results, the first recording generation unit 112 erases the value associated with the preceding item and associates the next recognized value with the item. In addition, if the speech command “pause” exists in the speech recognition results, the first recording generation unit 112 does not associate a result of the user's speech with the item until the speech command “resume” is subsequently detected. A specific guidance speech may be returned to the speech command. For example, the guidance generation unit 113 may generate a guidance speech of “recording will be pauses” after the speech command “pause.” The recognition results of the guidance speech are also utilized to achieve a process that is robust against speech recognition errors.

The processes shown in FIGS. 3 and 4 will be described below with specific examples. The examples are of entering numerical values by speech into tabular items such as a ledger. The items contain three items of “power supply voltage,” “current” and “rotation number.”

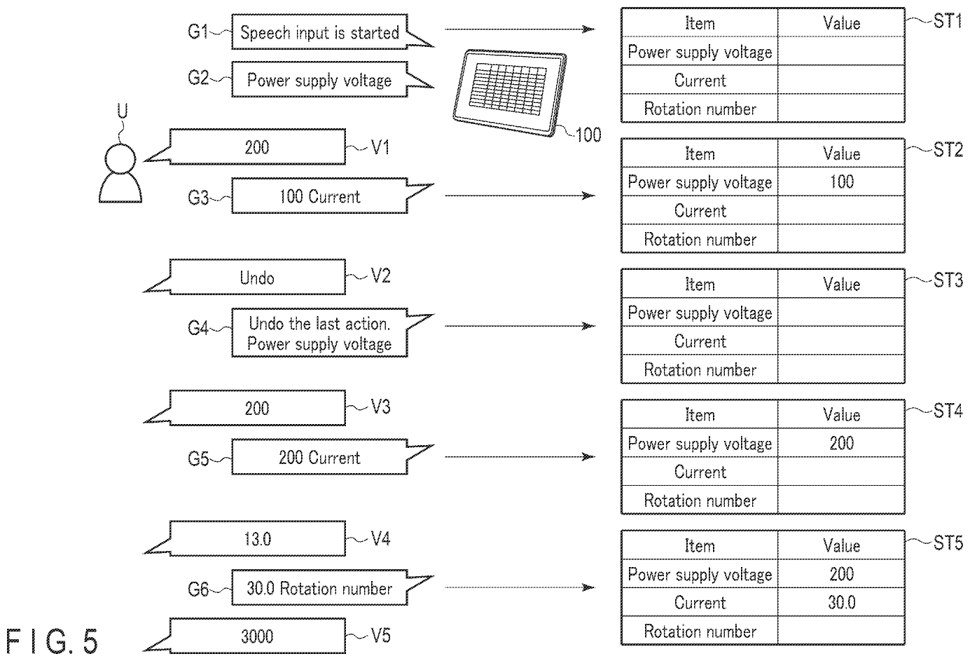

FIG. 5 is a diagram illustrating a state in which items are entered by speech using the speech input device 100 according to the embodiment. FIG. 5 also illustrates a state in which items are entered in a ledger.

When the speech input device 100 first starts speech input, it outputs to a user U a guidance speech G1 indicating that the speech input has been started. Then, the speech input device 100 outputs a guidance speech G2 that prompts the user U to enter “power supply voltage” as a first item. Since the user U has not spoken at this time, the state of the ledger is state ST1 in which no items are entered.

Upon receiving the guidance speech G1, the user U makes a speech V1 of the value of the corresponding item. The speech input device 100 recognizes the speech V1, reads the result aloud, records it in the ledger, and outputs the next item as a guidance speech G3. In the example, the user U speaks “200” as a value of the power supply voltage, while the speech input device 100 erroneously recognizes the content of the speech as “100.” As a result, the state of the ledger is state ST2 in which “100” is entered as the “power supply voltage,” and an erroneous content “100” is output as the guidance speech.

The user U who has listened to the guidance speech G3 notices that a speech recognition error has occurred and speaks a speech command V2 of “undo.” In response to this speech, the speech input device 100 cancels the last recording and outputs a guidance speech G4 that prompts the user to enter the last item again. As a result, the state of the ledger returns to state ST3 in which the entering of the value into the item “power supply voltage” is canceled from the state ST2 in which the value “100” is entered into the item “power supply voltage.”

After the guidance speech G4, the user U again makes a speech V3 of the value of the corresponding item. The speech input device 100 recognizes the speech V3, reads the result aloud, records it in the ledger, and outputs the next item as a guidance speech G5. In the example, the user U speaks “200” as the value of the power supply voltage, and the speech input device 100 correctly recognizes the content of the speech as “200.” As a result, the state of the ledger becomes state ST4 in which “200” is entered into “power supply voltage.”

The user U that has listened to the guidance speech G5 makes speech V4 of the value of the next item. The speech input device 100 recognizes the speech V4, reads the result aloud, records it in the ledger, and outputs the next item as a guidance speech G6. In the example, the user U speaks “13.0” as the value of the current, while the speech input device 100 erroneously recognizes the content of the speech as “30.0.” As a result, the state of the ledger is state ST5 in which “30.0 is entered into the item “current” and an erroneous content of “30.0” is also output as the guidance speech.

FIG. 5 also illustrates an example in which the user U makes a speech V5 of the value of the next item without noticing an error of the recognition content by the speech input device 100. In this example, if the entering of the “rotation number” is finally completed, the speech input is terminated. At this time, in the first recording content, the value of “current” is incorrectly recorded as “30.0.”

In the embodiment, a user's speech and a guidance speech to enter an item are recorded, and the recorded speech is recognized by the second speech recognition unit 122. In addition, a difference in speech recognition results between the first and second speech recognition units 111 and 122 is presented to the user. The speech recognition engine of the second speech recognition unit 122 may be a cloud-based speech recognition engine. Therefore, as the speech recognition engine of the second speech recognition unit 122, a speech recognition engine with higher accuracy than that of the first speech recognition unit 111 can be employed. Furthermore, the recognition result of the second speech recognition unit 122 is recorded to correspond to the next operation to the user held by the guidance generation unit 113. That is, both the first and second recording contents contain information on the next operation to the user, and a difference between the first and second recording contents is only the difference between the speech recognition results. If, therefore, the first and second recording contents are presented to the user, the user may notice a recognition error during entering into the speech input device 100.

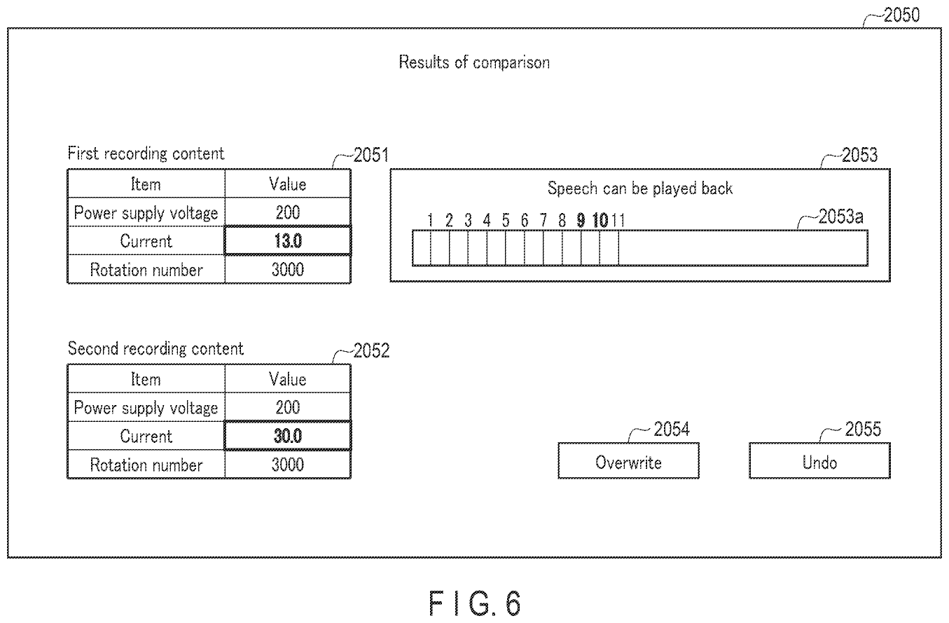

FIG. 6 is a diagram illustrating an example of a screen of results of comparison between the first and second recording contents in step S115. In FIG. 6, a comparison result screen 2050 includes, for example, a first recording result display field 2051, a second recording result display field 2052, a recorded speech playback field 2053, an overwrite button 2054 and an undo button 2055.

In the first recording result display field 2051, a ledger prepared based on the first recording content is displayed. In the first recording result display field 2051, a difference between the first and second recording contents is highlighted. In FIG. 6, the field of value “30.0” of item “current” is highlighted. The highlighting may be performed by any technique, such as thickening a corresponding frame, thickening characters of corresponding recognition results, and changing the color of the frame and/or characters.

In the second recording result display field 2052, a ledger prepared based on the second record contents is displayed. In the second recording result display field 2052, a difference between the first and second recording contents is highlighted. In FIG. 6, the field of value “13.0” of item “current” is highlighted. The highlighting may be performed by any technique, such as thickening the frame of a corresponding item, thickening characters of the corresponding item, and changing the color of the frame and/or characters of the corresponding item.

In the playback field 2053, for example, a playback bar 2053a is displayed. In the playback bar 2053a, numbers corresponding to recording times of a series of user's speeches and guidance speeches using the speech input device 100 are shown. Then, a number corresponding to a difference between the first and second recording contents is highlighted. For example, in FIG. 6, number 9 corresponding to the speech V4 and number 10 corresponding to the guidance speech G6 immediately after number 9 are highlighted in a series of input processes in FIG. 5. The user may select each number of the playback bar 2053a. Thus, a speech recorded at time corresponding to the selected number is played back. The user can thus notice a speech recognition error even from the played-back speech. FIG. 6 shows an example in which a number representing a time series is displayed, but the recording time of each speech may be displayed more directly. In addition, if each item or its value in the first and second recording result display fields 2051 and 2052 is selected and its corresponding speech is played back, it is easy to confirm an item with a difference.

The overwrite button 2054 is a button selected by the user when the first recording content is overwritten with the second recording content. If the overwrite button 2054 is selected, the first recording generation unit 112 overwrites the current first recording content with the second recording content. Note that if the recording content comparison section 120 is provided separately from the speech input device 100, the first recording generation section 112 acquires the second recording content from the second recording generation unit 123 by communication. Instead of using the overwrite button 2054, the first recording content may be overwritten with one of the first and second recording result display fields 2051 and 2052, which is selected by the user. In addition, the first recording content may be edited directly by the input device 204.

The undo button 2055 is a button selected by the user when the display is ended without overwriting the first recording content with the second recording content. If the undo button 2055 is selected, the first recording generation unit 112 does not overwrite the current first recording content with the second recording content.

As described above, according to the embodiment, when a user inputs his or her speech to the speech input device, speech recognition is performed separately from speech recognition for speech input. Then, a difference between the first recording content as a result of speech recognition for speech input and the second recording content as a result of separate speech recognition is presented to the user. In the embodiment, speech is input in accordance with guidance and information of the guidance is shared with the result of the separate speech recognition. Thus, the difference between the first and second recording contents is only a difference based on the results of speech recognition. Therefore, the first and second recording contents can appropriately be compared with each other. As a result, even if there is an error in speech recognition during speech input, the user can easily notice the error later.

Furthermore, in the embodiment, the recording content comparison unit 120 has only to be provided with information of the next operation with the user from the guidance generation unit 113, and no change to the speech recognition engine of the first speech recognition unit 111 is necessary. Therefore, as the speech recognition engine of the first speech recognition unit 111, an engine that can be implemented by a terminal with limited specifications can be adopted.

### Modification

A modification to the embodiment will be described below. In the speech input device 100 according to the embodiment, guidance speech is recognized in addition to user's speech to associate results of the recognition with items. However, the speech input device is not limited to the embodiment. For example, if the speech input device 100 is provided with an application that can be shared with a user by displaying the current speech input status on the screen, it may record the display screen to grasp information on the next operation. If speech is input, for example, to the items in the form of a table described above, information on the next operation can be grasped by detecting the table in the screen by image processing for images of the recorded display screen and then detecting an item to be entered next from the table. If it is detected that the last input value is newly displayed on an item, the next item can be set as an item to be entered next. In addition, if the frame of an item requesting a user to input speech on the display screen is thickened or its color is changed as guidance other than the guidance speech, the change in these features can be detected by image processing to identify an item to be entered next.

In addition, if the history of results of input speech recognition may be kept as a log, and the results of input speech recognition may be associated with the next operation from the log. In this case, it is desirable that the log also includes a history of which item was input targets during which time period. That is, if a time period during which user's speech is made and a time period during which guidance speech is output are recorded as a history, the results of input speech recognition can be associated with the next operation from these time periods.

The instructions in the process of the foregoing embodiment can be executed based on a program that is software. If a general-purpose computer system stores the program in advance and read the program, an advantage similar to that of the speech input support device described above. The instructions are recorded on a magnetic disk (flexible disk, hard disk, etc.), optical disk (CD-ROM, CD-R, CD-RW, DVD-ROM, DVD+R, DVD+RW, Blu-ray (registered trademark) Disc, etc.), a semiconductor memory, or similar recording medium, as a program that can be executed by a computer. If a computer or an embedded system is a readable recording medium, its storage format may be any form. If the computer reads a program from the recording medium and causes a CPU to execute the instructions described in the program based on the program, an operation similar to that of the speech input support device of the foregoing embodiment can be performed. Of course, the computer may acquire or read the program via a network.

In addition, an operating system (OS) running on a computer, database management software, middleware (MW) such as a network, and the like may perform some of the processes to achieve the embodiment, based on the instructions of programs installed on the computer and embedded system from the recording medium.

Furthermore, the recording medium of the present embodiment is not limited to a medium independent of a computer or an embedded system, but also includes a recording medium in which a program transmitted via a LAN, the Internet or the like is downloaded and stored or temporarily stored.

The number of recording mediums is not limited to one. Even if the process in the present embodiment is performed from a plurality of mediums, they are included in the recording medium of the present embodiment, and the medium may have any configuration.

Note that the computer or the embedded system in the present embodiment is intended to perform each process in the present embodiment based on the programs stored in a recording medium, and may have any configuration, such as a device including of one of a personal computer, a microcomputer and the like and a system to which a plurality of devices are connected via a network.

The computer in the present embodiment is not limited to a personal computer, but includes an arithmetic processing unit of an information processing device, a microcomputer, and the like, and collectively refers to an apparatus and a device capable of achieving the functions in the present embodiment by programs.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A speech input support device comprising:
a recording unit which records speech of a user using a speech input device; and
a processor including hardware configured to:
recognize the recorded speech separately from speech recognition for input of a first recording content by the speech input device;
generate a second recording content based on a result of the separately recognized speech and a next operation for the user for the input using the speech input device; and
compare the first recording content with the second recording content.

2. The speech input support device of claim 1, wherein:
the next operation for the user is to output guidance speech from the speech input device; and
the processor generates the second recording content by associating the result of the separately recognized speech with a result of recognition of the guidance speech.

3. The speech input support device of claim 2, wherein the processor:
records a series of speeches of the user and the guidance speech together; and
recognizes the speeches of the user and the guidance speech together.

4. The speech input support device of claim 3, wherein the processor:
recognizes the speech of the user and the guidance speech while maintaining a relationship in order therebetween;
associates the result of the separately recognized speech with the result of recognition of the guidance speech based on the relationship in order.

5. The speech input support device of claim 3, wherein the processor associates the result of the separately recognized speech with the result of recognition of the guidance speech based on a time period during which the speech of the user is made and a time period during which the guidance speech is output.

6. The speech input support device of claim 3, wherein:
the input using the speech input device is input to an item; and
the processor matches the result of recognition of the guidance speech with a name of the item at a phoneme level to associate the result of the separately recognized speech with the result of recognition of the guidance speech.

7. The speech input support device of claim 1, wherein:
the input using the speech input device is input of a value to an item; and
the processor performs matches the result of recognition of the guidance speech with a candidate of a value to be input to the item at a phoneme level to generate the second recording content using a candidate closest to the phoneme level as the value input to the item.

8. The speech input support device of claim 1, wherein the processor presents to the user time at which a difference between the first recording content and the second recording content occurred.

9. A non-transitory computer-readable storage medium which stores a speech input support program to cause a computer to:
record speech of a user using a speech input device;
recognize the recorded speech separately from speech recognition for input of a first recording content by the speech input device;
generate a second recording content based on a result of the separately recognized speech and a next operation for the user for the input using the speech input device; and
compare the first recording content with the second recording content.
